(19) United States
(12) Patent Application Publication
(10) Pub. No.: US 2024/0029196 A1
(43) Pub. Date: Jan. 25, 2024

(54) SYSTEM, DEVICES AND/OR PROCESSES FOR TEMPORAL UPSAMPLING IMAGE FRAMES

(71) Applicant: Arm Limited, Cambridge (GB)

(72) Inventors: Carlos Barragán del Rey, Manchester (GB); Yanxiang Wang, Manchester (GB); Liam James O'Neil, Bedale (GB); Matthew James Wash, Stapleford (GB)

(21) Appl. No.: 18/338,231

(22) Filed: Jun. 20, 2023

(30) Foreign Application Priority Data
Jul. 21, 2022 (GB) 2210700.7

(51) Int. Cl. G06T 3/40; G06T 3/00; G06T 1/20; G06V 10/56; G06V 10/60; G06V 10/80; G06V 10/82

(52) U.S. Cl. CPC G06T 3/40; G06T 3/0093; G06T 1/20; G06V 10/56; G06V 10/60; G06V 10/806; G06V 10/82

(57) ABSTRACT

Example methods, apparatuses, and/or articles of manufacture are disclosed that may be implemented, in whole or in part, techniques to process image signal values sampled from a multi color channel imaging device. In particular, methods and/or techniques disclosed herein are directed to synthesizing a temporally upsampled image frame to be in a temporal sequence of images frames.

This application claims the benefit of priority to UK patent application no. GB2210700.7 titled “SYSTEM, DEVICES AND/OR PROCESSES FOR TEMPORAL UPSAMPLING IMAGE FRAMES” and filed on Jul. 21, 2022, which is incorporated herein by reference in its entirety.

### BACKGROUND

### 1. Field

Techniques, devices and processes for temporal upsampling of image frames in a temporal sequence of image frames.

### 2. Information

Frame rate upsampling may comprise an artificial generation of additional image frames in a temporal sequence of image frames to, for example, smooth a perceived motion and increase a number of frames per second displayed with minimal impact to computing resource usage. In a particular implementation of a graphics use case, insertion of synthesized image frames may increase an effective frame rate to a temporal sequence of image frames rendered at lower frame rate. Such an image frame may be synthesized as an interpolation to be referenced between image frames rendered in a temporal sequence based on the rendered image frames. Alternatively, such an image frame may be synthesized as an extrapolation in which a synthesized image frame referenced to a current time is based on rendered image frames referenced to times in the past.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIGS. 1A and 1B are schematic diagrams of systems to implement a temporal interpolation and/or extrapolation of an image frame in a temporal sequence of image frames, according to an embodiment;

FIGS. 2 and 3 are schematic diagrams of an implementation of a temporal upsampling of an image frame in a temporal sequence of image frames in a graphics pipeline, according to interpolation embodiments;

FIG. 4 is a flow diagram of a process to generate a temporally upsampled image frame, according to an embodiment;

FIG. 5 is a schematic diagram of a neural network formed in “layers”, according to an embodiment; and

FIG. 6 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

According to an embodiment, an “image frame” as referred to herein is to be mean a set of parameters to represent attributes of an image (e.g., 2D or 3D image) that are to be viewable. For example, an image frame may define “pixels” to occupy locations on an image for which one or more image signal intensity values may be defined. In a multi-color channel image (e.g., with red, blue and green color channels), an image frame may define image signal intensity values for each color channel at each pixel location. In one particular embodiment, a still image may be represented by a single image frame. In another particular embodiment, a moving image may be represented by a “temporal sequence” of image frames. If a “frame rate” (e.g., determined by a period between image frames in a temporal sequence of image frames) is sufficiently high, transitions between image frames in a visual image may not be noticeable by a human viewer. As such, temporal sequences of image frames may be particularly effective in presenting moving images in video and/or computer graphics use cases.

According to an embodiment, image frames in a temporal sequence of image frames may be created or “rendered” from signals representing features of an image such as, for example, signals captured at an imaging device and/or signals derived and/or generated by a computing device. In a particular implementation, image frames in a temporal sequence of image frames may be rendered at, or to be referenced to, specific time instances in the temporal sequence of images. For example, a temporal sequence of image frames may comprise image frames rendered at and/or referenced to 30 time instances per second of the temporal sequence. In a particular implementation, an image frame in a temporal sequence of image frames may define image signal intensity values for each color channel and each pixel locations, and a time instance (e.g., referenced to a start time and/or a time prior or subsequent to adjacent image frames in the temporal sequence of image frames).

According to an embodiment, a temporal sequence of rendered image frames may be temporally upsampled by synthesizing one or more additional frames to be place in and/or inserted among the rendered image frames in the temporal sequence of image frames. Temporally upsampling of image frames in a temporal sequence of image frames may be implemented in multiple use cases such as, for example, graphic and video use cases. In the particular implementation of a graphics use case, motion vectors relating adjacent frames (e.g., available from a rendering pipeline) may indicate per pixel displacement between frames. According to an embodiment, a pipeline to implement synthesis of a temporally upsampled image frame may be implemented with the following:
motion vector interpolation (e.g., approximate motion vectors to an intermediate frame);
warping or depth-aware warping (e.g., create warped frames, as a first approximation of a target intermediate frame, using the approximated motion vectors and depth information to address occlusion and disocclusion cases); and
application of a neural network to predict an output used to obtain image signal intensity values of the synthesized image (e.g., a neural network with an encoder-decoder architecture to receive activation inputs such as warped images, with other information such as depth, etc.).

In a particular implementation, motion vectors associated with locations in an image may be computed by linear interpolation (or higher order approximation based on three or more image frames) to minimize a positional error between adjacent image frames in a temporal sequence of image frames. Warping may then be applied to obtain multiple different approximations of a synthesized frame to be referenced in the temporal sequence between the adjacent image frames. A neural network may then be applied to the multiple different approximations of a synthesized frame to generate image signal intensity values of the synthesized image frame as prediction output values.

Techniques to temporally upsample a temporal sequence of image frames by synthesizing an image frame of image signal intensity values predicted as outputs of a neural network may produce synthesized image frames with image signal intensity values of limited quantization and/or accuracy. In an embodiment, a neural network may predict residual values to be added to associated image signal intensity values of blended and warped frames to enable producing synthesized image frames with greater quantization for image signal intensity values and improved image accuracy.

Briefly, particular implementations are directed to execution of a neural network to predict: features of a residual and features of a mask based, at least in part, on features of one or more previous image frames rendered in a temporal sequence of image frames. Features of the mask may be applied to two or more warped image frames to provide approximated features of a temporally upsampled image frame to be in the temporal sequence of image frames. The approximated features of the temporally upsampled image frame may then be combined with values of the residual to provide an output temporally upsampled image frame.

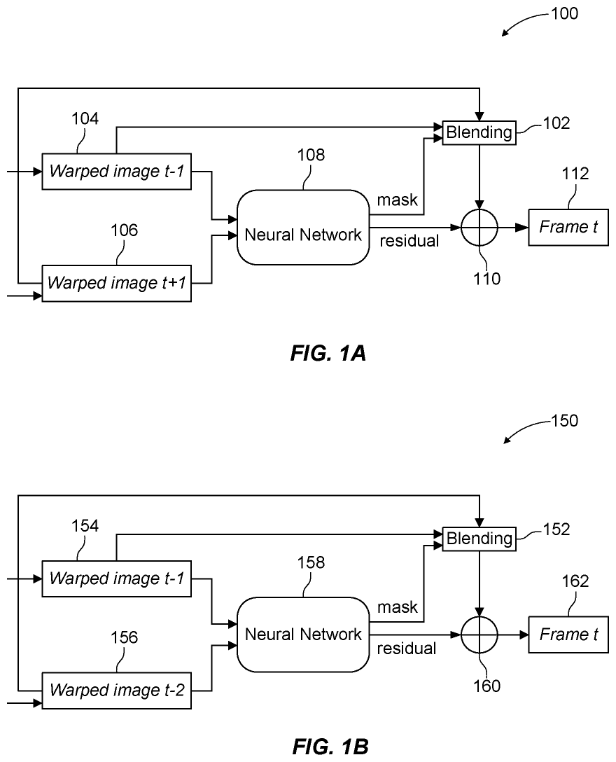

FIGS. 1A and 1B are schematic diagrams systems to implement a temporal upsampling of an image frame in a temporal sequence of image frames, according to an embodiment. In the particular implementation of system 100, a temporally upsampled image frame 112 to be referenced at a time instance t in the temporal sequence may be synthesized based, at least in part in on image signal intensity values of image frames referenced at time instances t−1 and t+1 of the temporal sequence. Warped image frames 104 and 106 may be generated by applying a warping operation (e.g., depth warping) to image signal intensity values of image frames referenced at time instances t−1 and t+1 based, at least in part, on computed motion vectors (e.g., obtained from a graphics pipeline buffer). Blending operation 102 may blend warped image frames 104 and 106 according to mask coefficients applied to image signal intensity values of warped image frame 104 and/or warped image frame 106 to approximate image signal intensity values of temporally upscaled image 112. For example, blending operation 102 may generate image signal intensity values of temporally upscaled image 112 according to expression (1) as follows:

BlendedFrame(t)=U_{i=1,j=1,c=1}^{i=1,j=j,c=C}[Mask_{i,j}×WarpedFrame_{i,j,c}(t−1)+(1−Mask_{i,j})×WarpedFrame_{i,j,c}(t+1)] (1)
where:
BlendedFrame(t) is an array of approximated image signal intensity values of a synthesized image frame to be reference to time t for color channels c∈1, . . . , C at pixel locations i,j for i∈1, 2, . . . , I and j∈1, 2, . . . , J;
Mask_{i,j} is a computed mask coefficient for pixel locations i,j for i∈1, 2, . . . , I and j∈1, 2, . . . , J;
WarpedFrame_{i,j,c}(t−1) is an image signal intensity value in an image frame warped to reference time t from an image rendered a time t−1 for color channels c∈1, . . . , C at pixel locations i,j for i∈1, 2, . . . , I and j∈1, 2, . . . , J; and
WarpedFrame_{i,j,c}(t+1) is an image signal intensity value in an image frame warped to reference time t from an image rendered a time t+1 for color channels c∈1, . . . , C at pixel locations i,j for i∈1, 2, . . . , I and j∈1, 2, . . . , J.

In a particular implementation, to maintain normalization of image pixel intensity values in BlendedFrame(t), values for mask coefficients Mask_{i,j} may be bounded in a range of 0.0 to 1.0. According to an embodiment, operation 110 may combine approximate image signal intensity values of a temporally upscaled image frame with values of a residual to provide image signal intensity values of temporally upscaled image frame 112 according to expression (2) as follows:

UpscaledFrame(t)=BlendedFrame(t)+Residual, (2)
where:
UpscaledFrame(t) is an array of image signal intensity values of a synthesized image frame to be reference to time t for color channels c∈1, . . . , C at pixel locations i,j for i∈1, 2, . . . , I and j∈1, 2, . . . , J; and Residual is an array of residual values for color channels c∈1, . . . , C at pixel locations i,j for i∈1, 2, . . . , I and j∈1, 2, . . . , J.

According to an embodiment, values for Mask_{i,j} and Residual may be computed as predictions of neural network 108 based, at least in part, on image signal intensity values of warped image frames 104 and 106 and/or other parameters (e.g., geometry, depth and/or other parameters obtained from a graphics pipeline buffer). In a particular implementation, neural network 108 may be constructed according to a so-called U-Net architecture including an encoder-decoder feature adapted to receive image signal intensity values of warped image frames 104 and 106 activation input values at an initial processing layer. Neural network 108 may implement a multiple outputs, one output to provide values for Mask_{i,j} and another output to provide values for Residual. According to an embodiment, a first output channel to provide values for Mask_{i,j} may comprise non-linear transform operations/functions at channel nodes implementing operations to limit values of Mask_{i,j} to between 0.0 and 1.0 as discussed above. Such non-linear transform operation/function to limit values of Maskᵢⱼ to between 0.0 and 1.0 may comprise a sigmoid or clipping operation, but other suitable operations may be implemented without deviating from claimed subject matter. Similarly, a second output channel to provide values for Residual may comprise non-linear transform operations/functions at channel nodes implementing operations to limit values of Residual to between −1.0 and 1.0. Such an operation to limit values Residual to between −1.0 and 1.0 may comprise a tan h operation, but other suitable operations may be implemented without deviating from claimed subject matter.

System 150 in FIG. 1B is an alternative implementation in which a temporally upscaled image frame 162 is synthesized for a time instance t in a temporal sequence based, at least in part, on multiple image frames rendered at two time instances prior to time instance t, time instances t−1 and t−2. Warped image frames 154 and 156 may be obtained from warping image frames rendered at times t−1 and t−2, respectively, as discussed above. In an inference iteration, neural network 158 may generate values for Mask_{i,j} on a first output channel and values for Residual on a second output channel based, at least in part, on image signal intensity values for warped image frames 154 and 156. Operation 160 may additively combine approximated image signal intensity values (generated by blending operation 152) with values for Residual to provide temporally upscaled image frame 162. Blending operation 152 may determine such approximated image signal intensity values of temporally upscaled image frame 162 according to expression (3) as follows:

BlendedFrame(t)=U_{i=1,j=1,c=1}^{i=I,j=J,c=C}[Mask_{i,j}×WarpedFrame_{i,j,c}(t−2)+(1−Mask_{i,j})×WarpedFrame_{i,j,c}(t−1)] (3)
where:
WarpedFrame_{i,j,c}(t−2) is an image signal intensity value in an image frame warped to reference time t from an image rendered a time t−2 for color channels c∈1, . . . , C at pixel locations i,j for i∈1, 2, . . . , I and j∈1, 2, . . . , J; and
WarpedFrame_{i,j,c}(t−1) is an image signal intensity value in an image frame warped to reference time t from an image rendered a time t−1 for color channels c∈1, . . . , C at pixel locations i,j for i∈1, 2, . . . , I and j∈1, 2, . . . , J.

The particular example implementations of FIGS. 1A and 1B are directed to synthesizing a temporally upscaled image frame referenced to time t based on image frames rendered at two times other than time t (e.g., times t−1 and t+1 in system 100 and time instances t−2 and t−1 in system 150). Other implementations may be directed to synthesizing a temporally upscaled image frame referenced to time t based on image frames rendered at three or more times other than time t. To accommodate synthesis of a temporally upscaled image frame referenced to time t based on image frames rendered at three or more time instances other than time instance t, according to an embodiment, expression (1) and/or expression (3) may be modified and/or generalized to expression (4) as follows:

BlendedFrame(t)=U_{i=1,j=1,c=1}^{i=I,j=J,c=C}[Mask_{i,j}(t−k)×WarpedFrame_{i,j,c}(t−k)+ . . . +Mask_{i,j}(t−1)×WarpedFrame_{i,j,c}(t−1)+Mask_{i,j}(t+1)×WarpedFrame_{i,j,c}(t+1)+ . . . +Mask_{i,j}(t+m)×WarpedFrame_{i,j,c}(t+m)], (4)

where:
Mask_{i,j}(t−k), . . . , Mask_{i,j}(t−1), Mask_{i,j}(t+1), . . . , Mask_{i,j}(t+m) are computed mask coefficients for color channels c∈1, . . . , C at pixel locations i,j for i∈1, 2, . . . , I and j∈1, 2, . . . , J, to be applied to image signal intensity values of image frame warped to reference time instance t based on images rendered at times t−k, . . . , t−1, t+1, . . . , t+m, respectively; and
WarpedFrame_{i,j,c}(t−k), . . . , WarpedFrame_{i,j,c}(t+1), WarpedFrame_{i,j,c}(t+1), . . . , WarpedFrame_{i,j,c}(t+m) are image signal intensity value in image frames warped to reference time t from image frames rendered at times t−k, . . . , t−1, t+1, . . . , t+m, respectively, for color channels c∈1, . . . , C at pixel locations i,j for i∈1, 2, . . . , I and j∈1, 2, . . . , J.

To maintain normalization, values for Mask_{i,j}(t−k), . . . , Mask_{i,j}(t−1), Mask_{i,j}(t+1), . . . , Mask_{i,j}(t+m) in expression (4) may be constrained such that Σₙ₌ₖⁿ⁼¹ Mask_{i,j}(t−m)+Σₚ₌₁^{p=m} Mask_{i,j}(t+p)=1.0.

According to an embodiment, weights to affect activation functions at nodes of neural network 108/158 may be updated and/or tuned in iterations of a machine learning process based, at least in part, on training sets. A training set for an iteration of such a machine learning process may include, for example, image signal intensity values for image frames rendered at times other than a time t (to be warped and provided as inputs to an inference engine), and image signal intensity values of an image rendered at time t to provide a ground truth label. Iterations of the machine learning process to update and/or tune weights to affect activation functions at nodes may be based, at least in part on a loss function according to expression (5) as follows:

$$, = {arg min}_{Data} E [ L ( {Mask}_{i , j} , Residual , Data ) ] , \qquad ( 5 )$$

where:
Data represents sets of training parameters (e.g., including image signal intensity values for image frames rendered at times other than time t (e.g., times t−1 and t+1 for neural network 108, times t−2 and t−1 for neural network 158) motion vectors and/or image signal intensity values of an image rendered at times t to provide a ground truth label); and
L(Mask_{i,j}, Residual, Data) is a loss function (e.g., based on a sum of squared errors) based, at least in part, on a comparison of image signal intensity values of a temporally upscaled image frame synthesized to be referenced at time t and image signal intensity values of a ground truth label image frame (e.g., an image frame rendered at time t).

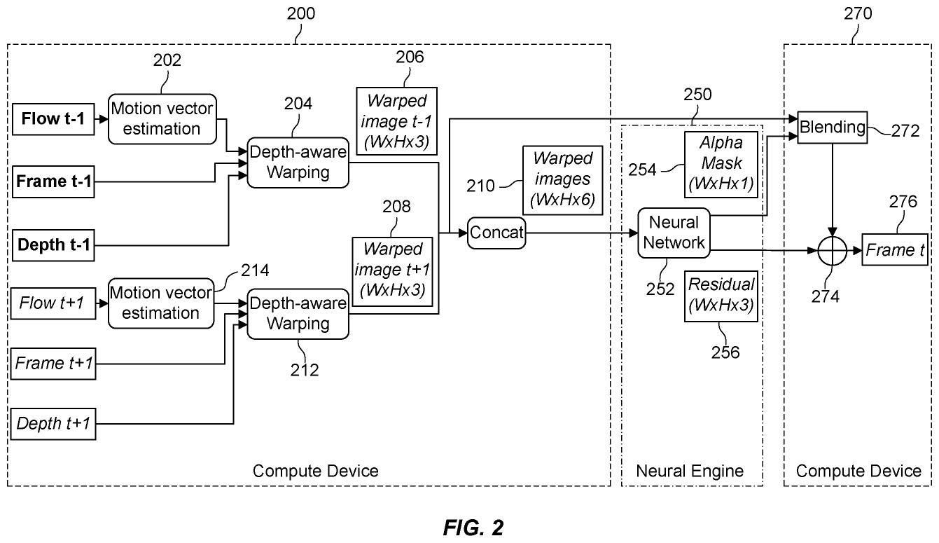

According to an embodiment, parameters for Data may comprise or be derived from a dataset consisting of a set of rendered sequences of image frames (e.g., together with associated parameters such as motion vectors, depth information, etc.) generated from a graphics pipeline. In an example implementation, for each iteration in a process to train neural network 108/158, three consecutive frames from a sequence (e.g., at times t−1, t, t+1). For example, image frames at times t−1 and t+1 may be provided as two inputs to a pipeline (e.g., as shown in FIG. 2), and an image frame at time t as a ground truth label. This may enable a trained neural network 108/158 to generate a mask and residual to be applied in generating a final frame prediction. Comparison of this generated prediction with a real frame at time t may be used as a training signal via loss function L(Mask_{i,j}, Residual, Data). Parameters of neural network 108/158 may then be updated/tuned based, at least in part on a gradient applied to L(Mask_{i,j}, Residual, Data) in backpropagation operations.

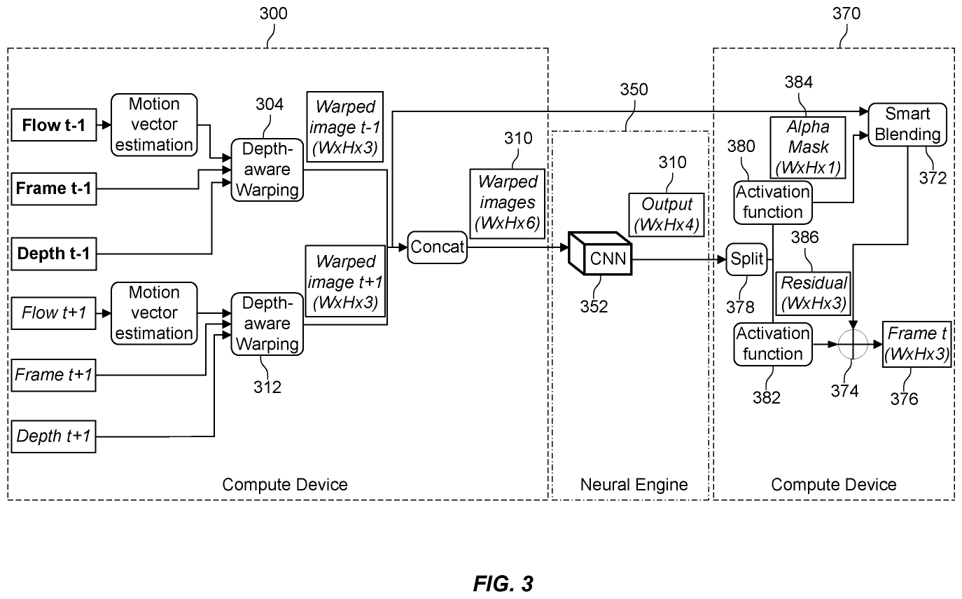

FIGS. 2 and 3 are schematic diagrams of an implementation of a temporal upsampling of an image frame in a temporal sequence of image frames in a graphics pipeline, according to alternative embodiments. In particular implementations, compute device portions 200 and 270 may be formed and/or implemented on one or more devices (e.g., integrated circuit devices) that are distinct and/or separate from one or more devices to implement neural network engine 250. Warping operations 204 and 212 may provide warped images 206 and 208, respectively, based, at least in part, on image frames rendered at times t−1 and t+1, and motion vectors obtained from blocks 202 and 214. Warped images 206 and 208 may be compressed and/or concatenated as warped images 210 to be processed to provide temporally upscaled image frame 276 to be referenced at time t. Neural network 252, formed on and/or implemented in neural network engine 250, may generate mask coefficients 254 (e.g., as Mask_{i,j}) and residual values 256 (e.g., as Residual) based, at least in part, on warped images 210 as discussed above. Blending operation 272 formed and/or implemented in shader portion 270 may generate approximated image signal intensity values for temporally upscaled image frame 276 based, at least in part, on warped images 210 and mask coefficients 254 according to expression (1), for example. Operator 274 may then provide temporally upscaled image frame 276 by combining residual values 256 the approximated image signal intensity values generated by blending operation 272 to provide temporally upscaled image frame 276 according to expression (2), for example.

In the particular implementation of FIG. 2, in implementing a multi-channel output to provide mask coefficients 254 in a first output channel and residual values 256 in a second output channel, neural network 252 may implement sigmoid operations as activation functions in nodes of the first output channel and implement tan h operations as activation functions in nodes of the second output channel. In an alternative implementation as shown in FIG. 3, final processing to provide mask values 384 may occur on compute device portion 370 using first activation function 380 (e.g., implemented as any one of several types of operators such as a sigmoid operator), and final processing to provide residual values 386 may occur on compute device portion 370 using second activation function 382 (e.g., implemented as any one of several types of operators such as a tan h operator). As such, particular types of activation functions, such as sigmoid operators and tan h operators, need not be implemented as activation functions for nodes at an output layer of neural network 352. Features of the implementation of FIG. 3 may enable application of a neural network with a single output with multiple channels to better integrate with some processing architectures and/or improve interface byte alignment.

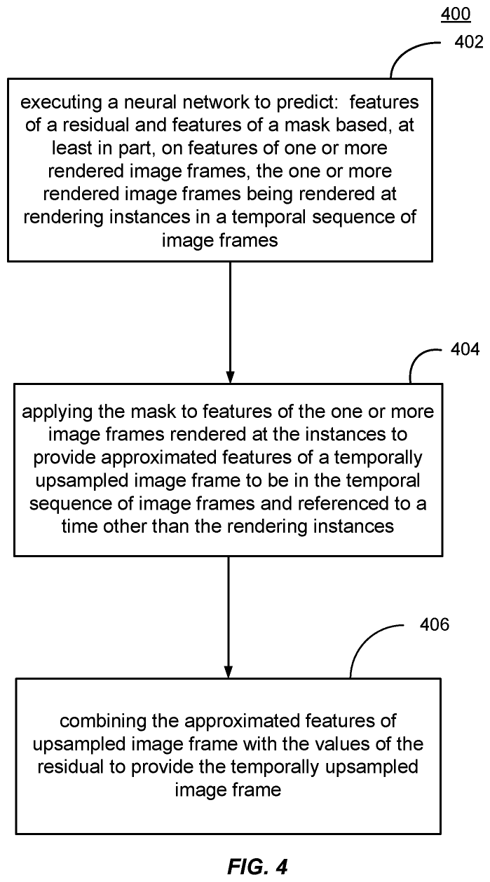

FIG. 4 is a flow diagram of a process to generate a temporally upsampled image frame, according to an embodiment. Such a temporally upsampled image frame may be synthesized to be referenced at a time instance t in a temporal sequence of image frames based, at least in part, on one or more image frames rendered at time instance(s) other than time instance t. In this context a rendered image frame in a temporal sequence of image frames may be associated with a “rendering instance” to mean a time instance in the temporal sequence to which the rendered image frame is referenced relative to time instances to be associated with other image frames in the temporal sequence. As such, placement of rendered image frames within a temporal sequence of image frames may be determined by rendering instances associated with the rendered image frames.

Image signal intensity values of one or more image frames rendered at time instances (and/or associated with rendering instances) other than time instance t may be warped at block 402 to reference time instance t (e.g., from application of stored motion vectors). Block 402 may comprise application of a neural network to one or more preprocessed (e.g., warped) image frames of a temporal sequency of image frames to generate a residual (e.g., Residual) and a mask (e.g., Mask_{i,j}). Block 404 may apply coefficients of a mask determined at block 402 to features of one or more image frames to provide approximated features of a temporally upsampled image frame to be in the temporal sequence. Such features of an image frame may comprise raw image signal intensity values associated with pixel locations in the image frame and/or attributes abstracted from such image signal intensity values, for example. In this context, “coefficients of a mask,” as referred to herein, means values to express a weighting between and/or among image signal intensity values associated with corresponding pixel locations in multiple image frames. Such coefficients of a mask may be applied to image signal intensity values associated with corresponding pixel locations in multiple image frames to provide an approximation of image signal intensity values associated with the corresponding pixel locations in a processed image frame. In this context, values of a “residual,” as referred to herein means numerical values to be combined with image signal intensity values associated with pixel locations in an image frame to provide associated image signal intensity values in a processed image frame. Block 406 may apply coefficients of a mask determined at block 404 in a process to blend image signal intensity values of warped image frames to approximate image signal intensity values of a temporally upscaled image frame as executed according to expressions (1), (3) or (4), for example. Block 408 may then combine values of a residual determined at block 404 with approximated image signal intensity values of a temporally upscaled image frame determined at block 406 according to expression (2), for example, to provide the temporally upscaled image frame.

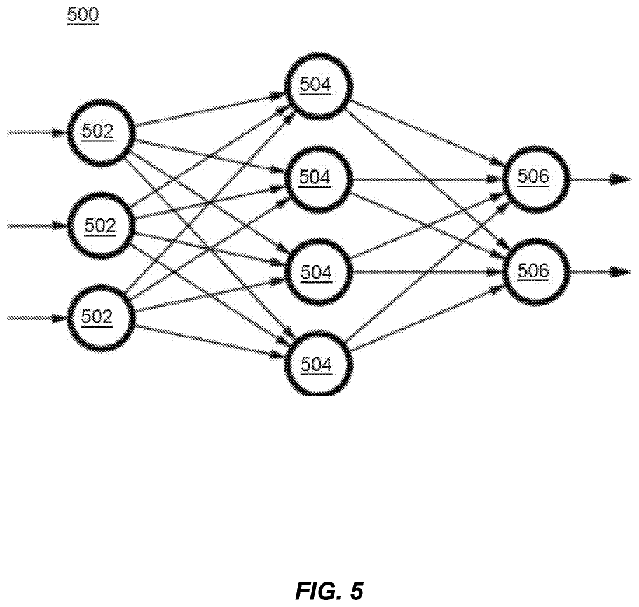

FIG. 5 is a schematic diagram of a neural network 500 formed in “layers” in which an initial layer is formed by nodes 502 and a final layer is formed by nodes 506. All or a portion of features of NN 500 may be implemented in neural network 108 (FIG. 1A) and/or 158 (FIG. 1B), for example. Neural network (NN) 500 may include an intermediate layer formed by nodes 504. Edges shown between nodes 502 and 504 illustrate signal flow from an initial layer to an intermediate layer. Likewise, edges shown between nodes 504 and 506 illustrate signal flow from an intermediate layer to a final layer. While neural network 500 shows a single intermediate layer formed by nodes 504, it should be understood that other implementations of a neural network may include multiple intermediate layers formed between an initial layer and a final layer.

According to an embodiment, a node 502, 504 and/or 506 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect. Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ back propagation techniques to iteratively update neural network weights to be associated with nodes and/or edges of a neural network based, at least in part on “training sets.” Such training sets may include training measurements and/or observations to be supplied as input values that are paired with “ground truth” observations. Based on a comparison of such ground truth observations and associated prediction values generated based on such input values in a training process, weights may be updated according to a loss function using backpropagation.

According to an embodiment, all or portions of system 100 and/or 150, neural engine 250 and/or 350, or computer shader portions 200, 270, 300 and/or 370 may be formed by and/or expressed, in whole or in part, in transistors and/or lower metal interconnects (not shown) in processes (e.g., front end-of-line and/or back-end-of-line processes) such as processes to form complementary metal oxide semiconductor (CMOS) circuitry, just as an example. It should be understood, however that this is merely an example of how circuitry may be formed in a device in a front end-of-line process, and claimed subject matter is not limited in this respect.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented to include, but not be limited to, formats supporting behavioral languages such as C, Verilog, and VHDL, formats supporting register level description languages like RTL, formats supporting geometry description languages such as GDSII, GDSIII, GDSIV, CIF, MEBES and any other suitable formats and languages. Storage media in which such formatted data and/or instructions may be embodied to include, but not be limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves may include, but not be limited to, transfers (uploads, downloads, e-mail, etc.) over the Internet and/or other computer networks via one or more electronic communication protocols (e.g., HTTP, FTP, SMTP, etc.).

If received within a computer system via one or more machine-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process (e.g., wafer fabrication process).

In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

For one or more embodiments, all or a portion of system 100 or system 150 may be implemented in a device, such as a computing device and/or networking device, that may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public. According to an embodiment, a signal packet and/or frame may comprise all or a portion of a “message” transmitted between devices. In an implementation, a message may comprise signals and/or states expressing content to be delivered to a recipient device. For example, a message may at least in part comprise a physical signal in a transmission medium that is modulated by content that is to be stored in a non-transitory storage medium at a recipient device, and subsequently processed.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

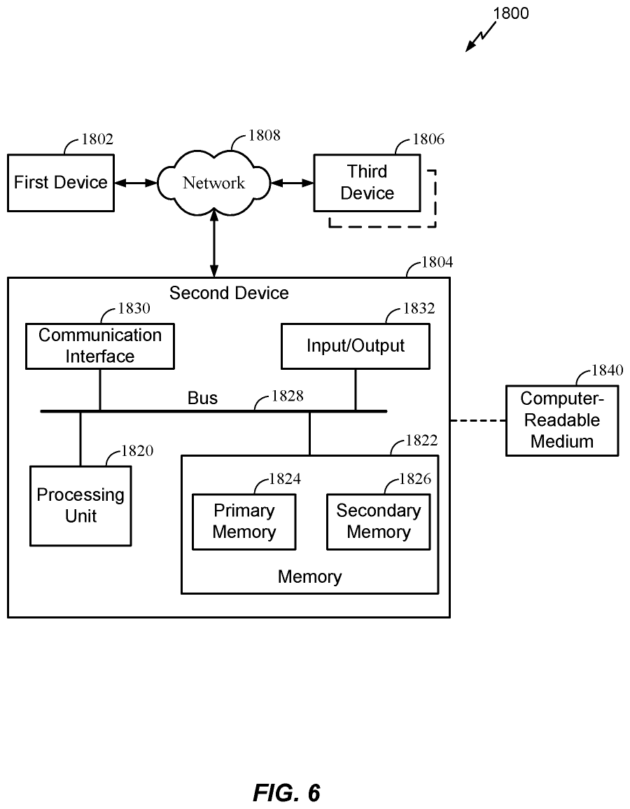

FIG. 6 shows an embodiment 1800 of a system that may be employed to implement either type or both types of networks. Network 1808 may comprise one or more network connections, links, processes, services, applications, and/or resources to facilitate and/or support communications, such as an exchange of communication signals, for example, between a computing device, such as 1802, and another computing device, such as 1806, which may, for example, comprise one or more client computing devices and/or one or more server computing device. By way of example, but not limitation, network 1808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 6 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1A through FIG. 4 and in the text associated with the foregoing figure(s) of the present patent application.

Referring now to FIG. 6, in an embodiment, first and third devices 1802 and 1806 may be capable of rendering a graphical user interface (GUI) for a network device and/or a computing device, for example, so that a user-operator may engage in system use. Device 1804 may potentially serve a similar function in this illustration. Likewise, in FIG. 6, computing device 1802 (‘first device’ in figure) may interface with computing device 1804 (‘second device’ in figure), which may, for example, also comprise features of a client computing device and/or a server computing device, in an embodiment. Processor (e.g., processing device) 1820 and memory 1822, which may comprise primary memory 1824 and secondary memory 1826, may communicate by way of a communication bus 1815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1804, as depicted in FIG. 6, is merely one example, and claimed subject matter is not limited in scope to this particular example. FIG. 6 may further comprise a communication interface 1830 which may comprise circuitry and/or devices to facilitate transmission of messages between second device 1804 and first device 1802 and/or third device 1806 in a physical transmission medium over network 1808 using one or more network communication techniques identified herein, for example. In a particular implementation, communication interface 1830 may comprise a transmitter device including devices and/or circuitry to modulate a physical signal in physical transmission medium according to a particular communication format based, at least in part, on a message that is intended for receipt by one or more recipient devices. Similarly, communication interface 1830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, GNSS receiver and/or other location-identifying type capability, and/or a display with a higher degree of functionality, such as a touch-sensitive color 5D or 3D display, for example.

In FIG. 6, computing device 1802 may provide one or more sources of executable computer instructions in the form physical states and/or signals (e.g., stored in memory states), for example. Computing device 1802 may communicate with computing device 1804 by way of a network connection, such as via network 1808, for example. As previously mentioned, a connection, while physical, may not necessarily be tangible. Although computing device 1804 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1822 may comprise any non-transitory storage mechanism. Memory 1822 may comprise, for example, primary memory 1824 and secondary memory 1826, additional memory circuits, mechanisms, or combinations thereof may be used. Memory 1822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1822 may be utilized to store a program of executable computer instructions. For example, processor 1820 may fetch executable instructions from memory and proceed to execute the fetched instructions. Memory 1822 may also comprise a memory controller for accessing device readable-medium 1840 that may carry and/or make accessible digital content, which may include code, and/or instructions, for example, executable by processor 1820 and/or some other device, such as a controller, as one example, capable of executing computer instructions, for example. Under direction of processor 1820, a non-transitory memory, such as memory cells storing physical states (e.g., memory states), comprising, for example, a program of executable computer instructions, may be executed by processor 1820 and able to generate signals to be communicated via a network, for example, as previously described. Generated signals may also be stored in memory, also previously suggested.

Memory 1822 may store electronic files and/or electronic documents, such as relating to one or more users, and may also comprise a computer-readable medium that may carry and/or make accessible content, including code and/or instructions, for example, executable by processor 1820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 6, processor 1820 may comprise one or more circuits, such as digital circuits, to perform at least a portion of a computing procedure and/or process. By way of example, but not limitation, processor 1820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. In various implementations and/or embodiments, processor 1820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 1804 as including a component 1832 operable with input/output devices, for example, so that signals and/or states may be appropriately communicated between devices, such as device 1804 and an input device and/or device 1804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method of generating an image frame comprising:
applying a neural network to at least one of one or more pre-processed image frames of a temporal sequence of image frames to generate a residual and a mask;
applying the mask to features of the one or more pre-processed image frames to provide approximated features of a temporally upsampled image frame to be in the temporal sequence of image frames; and
combining the approximated features of the temporally upsampled image frame with the residual to generate an output temporally upsampled image frame.

2. The method of claim 1, and further comprising:
warping one or more image frames of the temporal sequence of image frames to provide the one or more pre-processed image frames.

3. The method of claim 2, wherein warping the one or more image frames of the temporal sequence of image frames comprises applying motion vectors from a rendering pipeline to the one or more image frames of the temporal sequence of image frames to provide one or more approximations of the temporally upsampled image frame.

4. The method of claim 1, wherein the neural network is defined, at least in part, by parameters determined in training operations including:
generation of one or more image frames based, at least in part, on application of a generated mask and a generated residual;
application of a loss function to a comparison of a real image frame as a ground truth label to the generated one or more image frames; and
update of the parameters based, at least in part, on application of a gradient to the loss function.

5. The method of claim 1, and further comprising:
computing parameters of two or more warped image frames based, at least in part, on the features of at least one image frame of the temporal sequence of image frames rendered at rendering instances to at least in part provide the features of the at least one image frame of the temporal sequence of image frames rendered at the rendering instances,
and wherein applying the mask to features of the at least one image frame of the temporal sequence of image frames rendered at the rendering instances comprises applying the mask to the computed parameters of the two or more warped image frames to at least in part generate the approximated features of the temporally upsampled image frame.

6. The method of claim 1, and further comprising:
computing parameters of a first warped image frame based, at least in part, on the features of at least a first image frame of the temporal sequence of image frames rendered at a rendering instance in the temporal sequence prior to the temporally upsampled image frame;
computing parameters of a second warped image frame based, at least in part, on features of at least a second image frame of the temporal sequence of image frames; and
applying the mask to the parameters of the first and second warped image frames to at least in part generate the approximated features of the temporally upsampled image frame.

7. The method of claim 1, and further comprising:
computing parameters of a first warped image frame based, at least in part, on the features of at least a first image frame of the temporal sequence of image frames rendered at a rendering instance in the temporal sequence subsequent to the temporally upsampled image frame;
computing parameters of a second warped image frame based, at least in part, on features of at least a second image frame of the temporal sequence of image frames; and
applying the mask to the parameters of the first and second warped image frames to at least in part generate the approximated features of the temporally upsampled image frame.

8. The method of claim 1, and further comprising:
computing an approximated motion vector based, at least in part, on at least one image frame in the temporal sequence of image frames; and
computing a warped image frame based, at least in part, on the approximated motion vector to at least in part provide the features of the one or more pre-processed image frames.

9. The method of claim 1, wherein executing the neural network further comprises:
applying a sigmoid operation as an activation function to at least in part generate the features of the mask; and
applying a tan h operation as an activation function to at least in part generate the features of the residual.

10. The method of claim 1, and further comprising:
applying a sigmoid operation to the features of the mask to at least in part generate the features of the mask; and
applying a tan h operation to the features of the residual to at least in part generate the features of the residual.

11. The method of claim 1, wherein:
the features of one or more rendered image frames comprises image signal intensity values of a warped image frame of at least one of the one or more rendered image frames;
the features of the mask comprise coefficients to be applied to image signal intensity values associated with pixel locations and color channels of the warped image frame of at least one of the one or more rendered image frames; and
the features of the residual comprise values to be additively combined with approximated image signal intensity values of the temporally upsampled image frame.

12. The method of claim 1, wherein the neural network comprises activation functions defined in part by weights determined in iterations of a machine learning process according to a loss function, the loss function to be based, at least in part, on a temporally upscaled image frame to a reference time instance and an image frame rendered at the reference time instance applied as a ground truth label.

13. An article comprising:
a non-transitory storage medium comprising computer-readable instructions stored thereon which are executable by one or more processors of a computing device to:
apply a neural network to at least one of one or more pre-processed image frames of a temporal sequence of image frames to generate a residual and a mask;
apply the mask to features of at least one of the one or more pre-processed image frames to provide approximated features of a temporally upsampled image frame to be in the temporal sequence of image frames; and
combine the approximated features of the temporally upsampled image frame with the residual to generate an output temporally upsampled image frame.

14. The article of claim 13, wherein the instructions are further executable by the one or more processors to:
warp one or more image frames of the temporal sequence of image frames to provide the one or more pre-processed image frames.

15. The article of claim 14, wherein the one or images are to be warped by application of motion vectors from a rendering pipeline to the one or more image frames of the temporal sequence of image frames to provide one or more approximations of the temporally upsampled image frame.

16. The article of claim 13, wherein:
the features of one or more rendered image frames comprises image signal intensity values of a warped image frame of at least one of the one or more rendered image frames;
the features of the mask comprise coefficients to be applied to image signal intensity values associated with pixel locations and color channels of the warped image frame of at least one of the one or more rendered image frames; and
the features of the residual comprise values to be additively combined with approximated image signal intensity values of the temporally upsampled image frame.

17. A computing device comprising:
a memory; and
one or more processors coupled to the memory to:
apply a neural network to at least one of one or more pre-processed image frames of a temporal sequence of image frames to generate a residual and a mask;
apply the mask to features of the one or more pre-processed image frames to provide approximated features of a temporally upsampled image frame to be in the temporal sequence of image frames; and
combine the approximated features of the temporally upsampled image frame with the residual to generate an output temporally upsampled image frame.

18. The computing device of claim 17, wherein the one or more processors are further to:
warp one or more image frames of the temporal sequence of image frames to provide the one or more pre-processed image frames.

19. The computing device of claim 17, wherein the one or more processors are further to:
compute parameters of two or more warped image frames based, at least in part, on the features of at least one image frame of the temporal sequence of image frames rendered at rendering instances to at least in part provide the features of the pre-processed image frames rendered at the rendering instances,
and wherein application of the mask to features of the one or more pre-processed image frames comprises application of the mask to the computed parameters of the two or more warped image frames to at least in part generate the approximated features of the temporally upsampled image frame.

20. The computing device of claim 17, wherein the one or more processors are further to:
compute parameters of a first warped image frame based, at least in part, on the features of at least a first image frame of the temporal sequence of image frames rendered at a rendering instance in the temporal sequence prior to the temporally upsampled image frame;
compute parameters of a second warped image frame based, at least in part, on features of at least a second image frame of the temporal sequence of image frames; and
apply the mask to the parameters of the first and second warped image frames to at least in part generate the approximated features of the temporally upsampled image frame.
